(19) United States
(12) Patent Application Publication
(10) Pub. No.: US 2019/0311363 A1
(43) Pub. Date: Oct. 10, 2019

(54) LEDGER UPDATE NETWORK AND METHOD OF UPDATING A LEDGER

(71) Applicant: The Toronto-Dominion Bank, Toronto (CA)

(72) Inventors: Bryan Michael Gleeson, Bowmanville (CA); Igor Elkhinovich, Toronto (CA); Jeffrey Aaron Ecker, North York (CA); Adam Douglas McPhee, Waterloo (CA); Matta Wakim, Petersburg (CA); Kyryll Odobetskiy, Waterloo (CA); Dmitri Rabinovich, Richmond Hill (CA); John Jong-Suk Lee, Toronto (CA); Arun Victor Jagga, Toronto (CA)

(21) Appl. No.: 15/947,736

(22) Filed: Apr. 6, 2018

(51) Int. Cl. G06Q 20/40; G06Q 20/20; G06Q 30/02

(52) U.S. Cl. CPC G06Q 20/4012; G06Q 30/0233; G06Q 20/204

(57) ABSTRACT

A ledger update network includes a terminal and a server. The server includes or in communication with a database of ledgers each uniquely associated with an identifier. The terminal receives a primary value and one of the identifiers; generates a request message that includes the identifier and the primary value; and generates an update command by (i) selecting a rule from a database, and (ii) generating a secondary value from the selected rule. The update command includes the identifier and the secondary value. The terminal transmits the request message and the update command to the server. The server transmits to the terminal an authorization response that confirms authorization of a transaction characterized by the identifier and the primary value. Without referencing the database and without first responding to the update command, the server posts the secondary value to the ledger that is associated with the identifier.

### FIELD

This patent application relates to a network and method for updating a ledger. In particular, this patent application describes a network and method for updating a ledger using a point-of-sale terminal and a computer server.

### BACKGROUND

A consumer might elect to use a point-of-sale (POS) terminal to effect an electronic payment to a merchant. The POS terminal may read a card number from the consumer's payment card (e.g. credit card or debit card), and transmit the payment card number and a transaction amount to the payment card issuer. After the payment card issuer authorizes the payment, the card issuer server may transmit an authorization response to the POS terminal confirming that the payment for the transaction was authorized.

The POS terminal may also read a card number from the consumer's loyalty card, and transmit to the loyalty card issuer a request message requesting that the loyalty card issuer update a points balance in a loyalty card ledger that is associated with the card number. The loyalty card issuer may calculate a loyalty points award for the transaction, and use the loyalty points award to update the points balance in the loyalty card ledger. The loyalty card issuer server may then transmit a response message to the POS terminal advising whether loyalty points were awarded, and the loyalty points awarded (if any) for the transaction.

### SUMMARY

This patent application discloses a network, point-of-sale terminal, and associated method in which the point-of-sale terminal computes an authorization value, transmits the authorization value and token identifier to a computer server, and the computer server posts the authorization value to a ledger without further communicating with the point-of-sale terminal.

In accordance with a first aspect of this disclosure, there is provided a ledger update network that includes a point-of-sale terminal and a computer server. The computer server may include a database that comprises a plurality of ledgers that are each uniquely associated with a respective token identifier.

The point-of-sale terminal, in accordance with this first aspect, is configured to receive a primary authorization value and one of the token identifiers, and to generate an authorization request message that includes the received token identifier and the primary authorization value.

The point-of-sale terminal, in accordance with this first aspect, is also configured to generate an update command by (i) selecting a rule from a rules database that includes at least one of the rules, and (ii) generating a secondary authorization value from at least the selected rule. The update command may include the received token identifier and the secondary authorization value. The point-of-sale terminal is also configured to transmit the authorization request message and the update command to the computer server.

The computer server, in accordance with this first aspect, is configured to receive the authorization request message and the update command from the point-of-sale terminal, and to transmit an authorization response message to the point-of-sale terminal. The authorization response message confirms authorization of a transaction that is characterized by the received token identifier and the primary authorization value. The computer server is also configured to post (without referencing the rules database and without first responding to the update command) the secondary authorization value to the ledger that is associated with the received token identifier.

In accordance with a second aspect of this disclosure, there is provided a method of updating ledgers that are each uniquely associated with a respective token identifier.

The method, in accordance with this second aspect, involves a point-of-sale terminal receiving a primary authorization value and one of the token identifiers, and generating an authorization request message that includes the received token identifier and the primary authorization value.

The method, in accordance with this second aspect, also involves the point-of-sale terminal generating an update command by (i) selecting a rule from a rules database that includes at least one of the rules, and (ii) generating a secondary authorization value from at least the selected rule. The update command may include the received token identifier and the secondary authorization value. The point-of-sale terminal then transmits the authorization request message and the update command to a computer server.

The method, in accordance with this second aspect, involves the computer server receiving the authorization request message and the update command from the point-of-sale terminal, and transmitting an authorization response message to the point-of-sale terminal. The authorization response message confirms authorization of a transaction that is characterized by the received token identifier and the primary authorization value. Without referencing the rules database, and without first responding to the update command, the computer server posts the secondary authorization value to the ledger that is associated with the received token identifier.

In accordance with a third aspect of this disclosure, there is provided a point-of-sale terminal that includes a data input device, a display device, a token interface, a memory, and a data processor. The memory stores a rules database that includes at least one rule.

The data processor is in communication with the data input device, the display device, the token interface and the memory, and is configured to receive a primary authorization value from the data input device, receive a token identifier from an identity token that is interfaced with the token interface, generate an authorization request message, and generate an update command. The authorization request message includes the token identifier and the primary authorization value.

The data processor is configured to generate the update command by selecting a rule from the rules database, and generating a secondary authorization value from at least the selected rule. The update command includes the token identifier and the secondary authorization value.

The data processor is configured to transmit the authorization request message to a computer server, and receive from the computer server an authorization response message that confirms authorization of a transaction characterized by the token identifier and the primary authorization value.

The data processor is also configured to display the secondary authorization value on the display device, and to transmit the update command to the computer server after displaying the secondary authorization value.

In one implementation, the point-of-sale terminal transmits the update command by (i) receiving (from the computer server) a range qualifier that identifies a range of token identifiers, and (ii) confirming that the received token identifier correlates with the range. Additionally, or alternatively, the point-of-sale terminal may compute the secondary authorization value from the primary authorization value and the selected rule.

In one implementation, the point-of-sale terminal transmits the authorization request message to the computer server via a primary communications network, and transmits the update command to the computer server via a secondary network that is different from the primary communications network.

Since, in accordance with the foregoing aspects of the disclosure, the point-of-sale terminal generates the secondary authorization value, and the computer server posts the secondary authorization value to the ledger without referencing any rules database, the processing load on the computer server is reduced in comparison to conventional systems.

Further, since the computer server does not receive an update request message to update the ledger (which would then necessitate a corresponding update response message advising whether the update request was authorized or declined), but instead receives an update command commanding the computer server to update the ledger, the ledger update method allows the computer server to post the secondary authorization value to the ledger without responding to the update command. Consequently, the bandwidth requirements of the communications networks is reduced in comparison to conventional systems.

### BRIEF DESCRIPTION OF THE DRAWINGS

An exemplary ledger update network, point-of-sale terminal, and method for updating a ledger will now be described, with reference to the accompanying drawings, in which:

FIG. 1 is a schematic view of the ledger update network, depicting a point-of-sale terminal, an acquirer server and a ledger update server;

FIG. 2 is a schematic view of one of the point-of-sale terminals;

FIG. 3 is a schematic view of the ledger update server; and

FIG. 4 is a message flow diagram depicting the method of updating a ledger.

### DETAILED DESCRIPTION

### Ledger Update Network

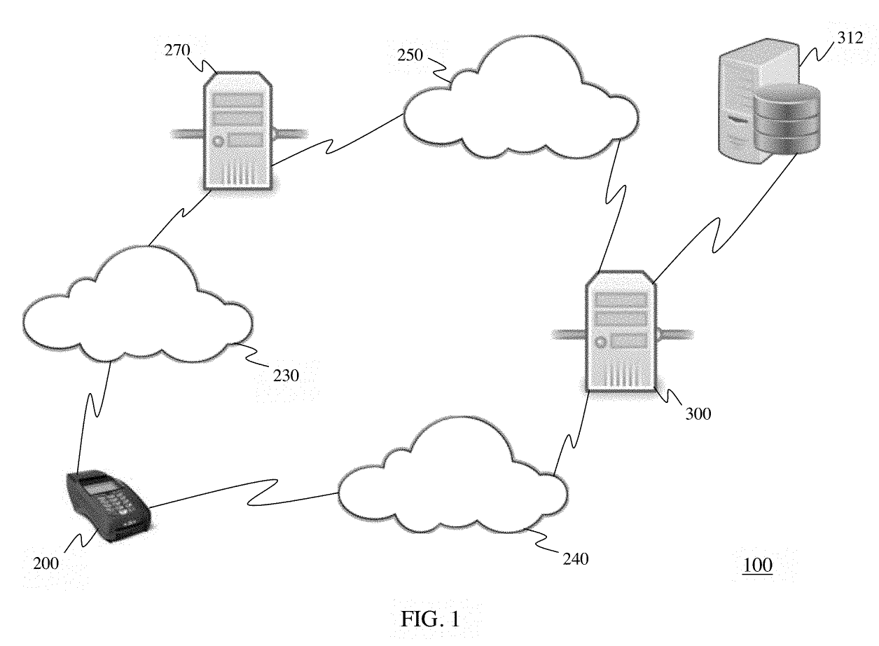

FIG. 1 is a schematic view of the ledger update network, denoted generally as 100. As shown, the ledger update network 100 includes a point-of-sale (POS) terminal 200, an acquirer server 270 and a ledger update server 300, and is configured to receive and process authorization request messages and update commands received from the POS terminals 200.

As will be discussed, the POS terminals 200 generate, and send to the ledger update server 300, authorization request messages each including an authorization amount and a token identifier. The ledger update server 300 uses the information included in the authorization request messages to authorize respective financial transactions that are initiated at the respective POS terminals 200.

The POS terminals 200 also generate, and send to the ledger update server 300, update commands each including a respective token identifier. The ledger update server 300 uses the information included in the update commands to update ledgers that are associated with the respective token identifiers. Typically, the ledgers track loyalty point transactions (e.g. loyalty point awards, loyalty point redemptions) that are executed using the respective token identifiers.

The POS terminals 200 are typically deployed at a merchant's business premises, and are configured to communicate with one of the acquirer servers 270 and the ledger update servers 300. As non-limiting examples, one or more of the POS terminals 200 may be implemented as an integrated point-of-sale terminal, or as a pin-pad terminal that communicates with respective electronic cash register (ECR).

Each acquirer server 270 is associated with a respective financial institution, and is configured to communicate with the POS terminals 200 via a respective secure communications (acquirer) network 230. The acquirer servers 270 are also configured to communicate with the ledger update server(s) 300 via a secure communications (payment) network 250, such as VisaNet or the Mastercard Network.

Each ledger update server 300 may be associated with and administered by a respective financial institution. Each ledger update server 300 maintains a plurality of token identifiers each in association with a respective financial account ledger and a respective loyalty points ledger, and is configured to communicate with the acquirer servers 270 via the respective payment network 250.

Each ledger update server 300 is also configured to communicate with the POS terminals 200 via a respective loyalty rewards network 240. Typically, the loyalty rewards network 240 does not include any acquirer servers 270 as nodes thereof and, therefore, each loyalty rewards network 240 is distinct from the acquirer networks 230 and the payment networks 250.

The financial institution associated with the respective ledger update server 300 may issue (or may authorize a third party to issue) identity tokens 226 to customers of the financial institution. Accordingly, each said financial institution will also be referred to herein as a “token issuer”.

The identity tokens 226 may have a contact form factor and/or a contactless form factor (e.g. ISO 7810), and may be implemented as plastic magnetic stripe cards and/or as plastic integrated circuit cards that include a built-in micro-controller and a protected memory. Alternately, the identity tokens 226 may be implemented in software executing on a portable communications device, such as a smart phone. Regardless of the configuration of the identity token 226, each identity token 226 stores a respective one of the token identifiers, encoded in the magnetic stripe thereof (if any) and/or in the memory/software thereof (if any). Therefore, each identity token 226 is configured with one of the token identifiers and is, therefore, uniquely associated with one of the token identifiers.

Although the ledger update network 100 is shown comprising only a single POS terminal 200, a single acquirer server 270 and a single ledger update server 300, the ledger update network 100 typically includes a plurality of the POS terminals 200, a plurality of the acquirer servers 270, and a plurality of the ledger update servers 300.

### POS Terminal

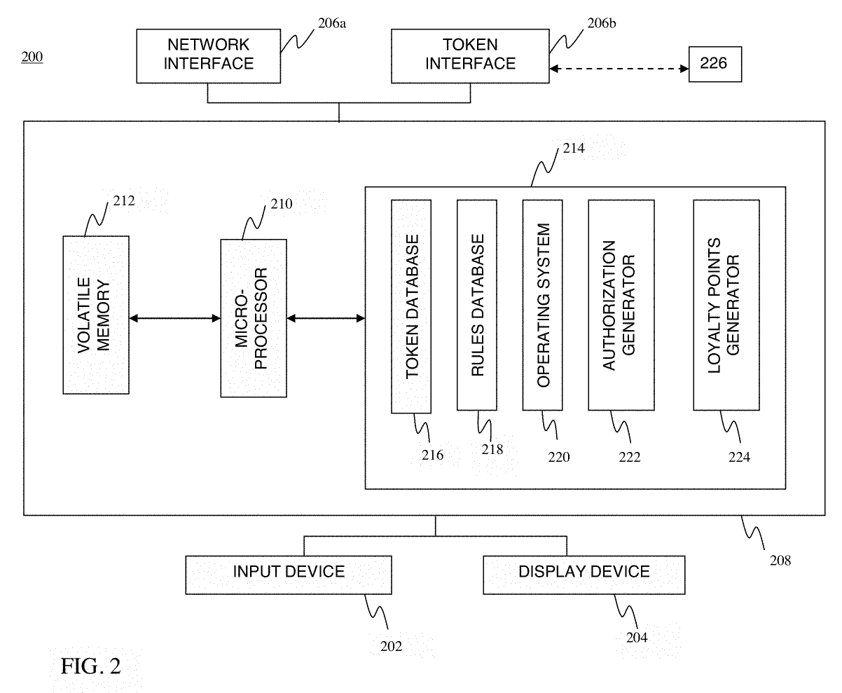

As shown in FIG. 2, the POS terminal 200 includes an input device 202, a display device 204, a network interface 206a, a token interface 206b, and a data processing subsystem 208 that is in communication with the input device 202, the display device 204, the network interface 206a and the token interface 206b.

The input device 202 may be implemented as a keyboard, touchpad, touchscreen or other input device suitable for allowing a user of the POS terminal 200 to input data and/or commands that may be required to complete a financial transaction with the merchant. The display device 204 may be implemented as a liquid crystal display (LCD) panel, cathode ray tube (CRT) display, plasma display panel, and/or printer and/or other device suitable for displaying transaction information to the user.

The network interface 206a interfaces the POS terminal 200 with the merchant's local area network (and, therefore, the acquirer network 230).

The token interface 206b is configured to communicate with an identity token 226 that is interfaced with the POS terminal 200. If the identity token 226 has a contact form factor, the token interface 206b may be a physical port (e.g. smartcard reader) that allows the POS terminal 200 to communicate directly with the identity token 226. If the identity token 226 has a contactless form factor, the token interface 206b may be a wireless interface that allows the POS terminal 200 to communicate with the identity token 226 via a wireless card transmission protocol, such as ISO 14443. Alternately, if the identity token 226 is implemented as software within a portable communications device, the token interface 206b may be a wireless interface that allows the POS terminal 200 to communicate with the portable communications device using short-range communications protocols, such as Bluetooth and/or Near Field Communications (NFC) as examples.

The data processing subsystem 208 of the POS terminal 200 includes a microprocessor 210, a volatile computer-readable memory 212 and a non-volatile non-transient computer-readable memory 214. The non-transient computer-readable memory 214 may be provided as a non-volatile electronic computer memory (e.g. FLASH memory). The non-transient memory 214 may store a token database 216 and/or a rules database 218. Alternately, the token database 216 and/or the rules database 218 may be stored on an ECR that is associated with each POS terminal 200, or on a local server (not shown) that serves the POS terminals 200 on the merchant's local area network.

The token database 216 stores token identifiers of loyalty points ledgers to which each token issuer has authorized the POS terminal 200 to award loyalty points. The token database 216 may store one or more ranges of token identifiers of the identity tokens 226 (“authorized token identifier ranges”) for which the respective token issuers have authorized the POS terminal 200 to award loyalty points. As will be discussed, the POS terminal 200 may use the authorized token identifier ranges to determine whether loyalty points can be awarded for a particular transaction.

The rules database 218 may store one or more rules that define parameters that the POS terminal 200 may use to determine the quantum of the loyalty points that can be awarded for a particular transaction.

The quantum may be a fixed amount that is the same for each transaction. Therefore, the rules database 218 may identify the fixed quantum of loyalty points that should be awarded for each transaction.

Alternately, the quantum may be a function of the amount paid (“authorization amount”) for the goods/services purchased in the transaction. Therefore, each rule in the rules database 218 may identify a respective range of authorization amounts and a weight factor that is applicable to the associated range.

Alternately, or additionally, the quantum of the loyalty point award may be a function of the class of goods/services purchased in the transaction. Therefore, each rule in the rules database 218 may identify the Stock Keeping Unit (SKU) of a group of goods/services, and the weight factor that is applicable to the associated SKU(s).

The non-transient memory 214 also includes computer processing instructions stored thereon which, when copied into the volatile computer-readable memory 212, and executed by the microprocessor 210 from the volatile computer-readable memory 212, implement an operating system 220, an authorization generator 222, and a loyalty points generator 224. The operating system 220 allows the POS terminal 200 to accept user input from the input device 202 and to control the display device 204, the network interface 206a and the token interface 206b.

The operation of the authorization generator 222 and the loyalty points generator 224 will be discussed in greater detail below. However, it is sufficient at this point to note that the authorization generator 222 is configured to receive a token identifier and a authorization amount, to generate an authorization request message from the token identifier and the authorization amount, and to transmit the authorization request message to the token issuer server 300 (e.g. via the associated acquirer network 230 and acquirer server 270). The authorization request message includes the token identifier and the authorization amount, and requests authorization from the ledger update server 300 for a financial transaction in an amount equal to the authorization amount.

The authorization generator 222 may receive the token identifier from an identity token 226 that is interfaced with the token interface 206b, and may receive the authorization amount from the input device 202. Alternately, the authorization generator 222 may receive both the token identifier and the authorization amount from the input device 202.

The loyalty points generator 224 is configured to determine whether loyalty points should be awarded for a particular transaction and, if so, to determine the quantum of loyalty points to be awarded for the transaction. The loyalty points generator 224 is also configured to generate an update command, and to transmit the update command to the token issuer server 300 (e.g. via the associated loyalty rewards network 240). The update command includes the quantum of the loyalty points award and the token identifier, and commands the ledger update server 300 to update the balance of loyalty points in the loyalty point ledger that is associated with the specified token identifier.

As discussed, the token database 216 may store one or more ranges of token identifiers of identity tokens 226 (“authorized token identifier ranges”) for which the respective token issuers have authorized the POS terminal 200 to award loyalty points. Therefore, the loyalty points generator 224 may be configured to determine whether loyalty points should be awarded for a particular transaction by querying the token database 216 with the token identifier to thereby confirm that the token identifier correlates with one of the authorized token identifier ranges stored in the token database 216.

The loyalty points generator 224 may be configured to determine the quantum of the loyalty points award from at least one of the rules in the rules database 218. As discussed, the rules database 218 may identify a fixed quantum of loyalty points that should be awarded for all transactions. Therefore, in this implementation, the loyalty points generator 224 may be configured to determine the quantum of the loyalty points award from the fixed quantum stored in the rules database 218.

The loyalty points generator 224 may be configured to determine the quantum of the loyalty points award by (i) selecting one of the rules from the rules database 218, and (ii) generating the quantum of the loyalty points award from at least the selected rule.

The loyalty points generator 224 may be configured to generate the quantum of the loyalty points award from the selected rule and from the authorization amount. Therefore, in one implementation, each rule in the rules database 218 identifies a respective range of authorization amounts and a weight factor that is applicable to the associated range. In this implementation, the loyalty points generator 224 may be configured to select one of the rules by querying the rules database 218 with the authorization amount to thereby retrieve from the rules database 218 a rule having a range of authorization amounts that correlates with the authorization amount.

The loyalty points generator 224 may be configured to select one of the rules after confirming that the token identifier correlates with one of the authorized token identifier ranges stored in the token database 216. The loyalty points generator 224 may be configured to generate the quantum of the loyalty points award by multiplying the authorization amount by the weight factor that is included in the retrieved rule.

The loyalty points generator 224 may be configured to generate the quantum of the loyalty points award from the selected rule and from the class(es) of good(s)/service(s) being purchased. Therefore, in another implementation, each rule in the rules database 218 identifies a respective group of SKUs and the weight factor that is applicable to the associated SKU group. In this implementation, the loyalty points generator 224 may be configured to select one of the rules by querying the rules database 218 with one of the SKUs of the good(s)/service(s) purchased to thereby retrieve from the rules database 218 a rule having a group of SKUs that correlates with the SKU of the good/service.

As above, the loyalty points generator 224 may be configured to select one of the rules after confirming that the token identifier correlates with one of the authorized token identifier ranges stored in the token database 216. The loyalty points generator 224 may be configured to generate the quantum of the loyalty points award by multiplying the authorization amount by the weight factor that is included in the retrieved rule.

The loyalty points generator 224 may be configured to generate the quantum of the loyalty points award from the selected rule and from the authorization amount and the class of good/service being purchased. Therefore, in another implementation, each rule in the rules database 218 identifies a respective range of authorization amounts, a respective group of SKUs and the weight factor that is applicable to the associated range of authorization amounts and SKU group. In this latter implementation, the loyalty points generator 224 may be configured to select one of the rules by querying the rules database 218 with the authorization amount and the SKU of the good/service purchased to thereby retrieve from the rules database 218 a rule having a range of authorization amount and a group of SKUs that respectively correlate with the authorization amount and the SKU of the good/service.

As above, the loyalty points generator 224 may be configured to select one of the rules after confirming that the token identifier correlates with one of the authorized token identifier ranges stored in the token database 216. The loyalty points generator 224 may be configured to generate the quantum of the loyalty points award by multiplying the authorization amount by the weight factor that is included in the retrieved rule.

Although the loyalty points generator 224 is typically implemented as computer processing instructions, all or a portion of the functionality of the loyalty points generator 224 may be implemented instead in electronics hardware, such as a field programmable logic gate array (FPGA) or a complex programmable logic device (CPLD).

### Ledger Update Server

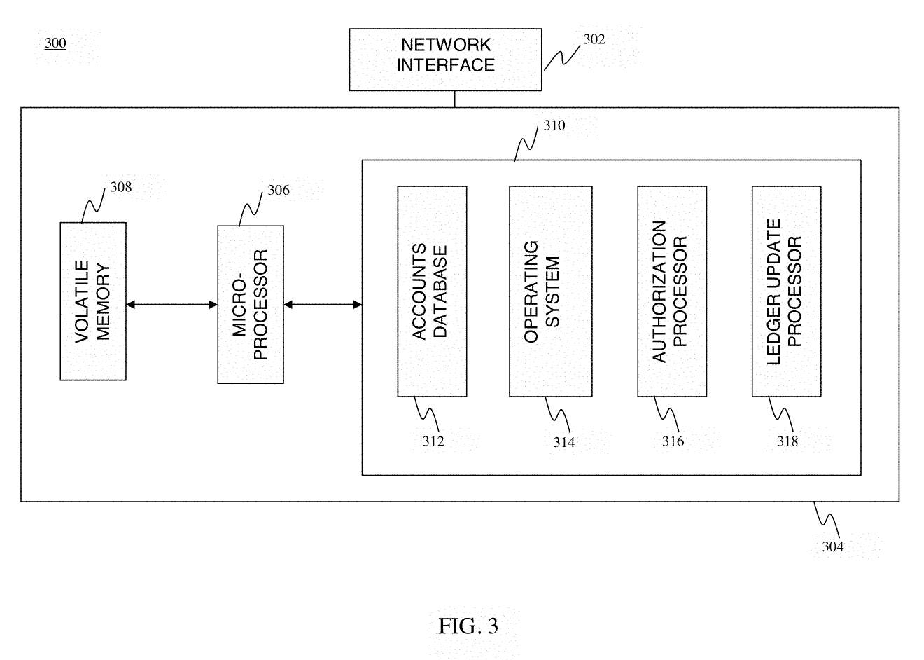

As shown in FIG. 3, the ledger update server 300 includes a network interface 302, and a data processing subsystem 304 that is coupled to the network interface 302. The network interface 302 interfaces the ledger update server 300 with the POS terminal(s) 200 via the acquirer server(s) 270 and the associated acquirer network 230. The network interface 302 also interfaces the ledger update server 300 with the POS terminal(s) 200 via the loyalty rewards network 240.

The data processing subsystem 304 includes one or more microprocessors 306, a volatile computer-readable memory 308 and a non-transient computer-readable medium 310. The non-transient computer-readable medium 310 may be provided as one or more of a magnetic storage drive and a solid-state drive, and may store a secure accounts database 312. Alternately, the secure accounts database 312 may be deployed on a database server (not shown) that is distinct from the ledger update server 300, and the ledger update server 300 may be configured to access the secure accounts database 312 via a secure communications channel.

The accounts database 312 may include a plurality of database records each uniquely associated with a respective financial ledger, a respective loyalty points ledger and a respective one of the token identifiers. Each database record identifies the associated token identifier, deposit/withdrawal entries to the associated financial ledger, and award/redeem loyalty point entries to the associated loyalty points ledger.

Alternately, instead of the accounts database 312 including both the financial ledgers and the loyalty points ledgers, the financial ledgers and the loyalty points ledgers may be stored in distinct databases that are stored in the computer-readable medium 310 or remotely from the ledger update server 30. In this variation, preferably each financial ledger is linked to one of the loyalty points ledger by a common data element, such as the respective token identifier, for example.

As discussed, each identity token 226 stores and is uniquely associated with one of the token identifiers. The token issuer server 300 may ensure that each token identifier is uniquely associated with an identity token 226 by employing any suitable database and/or cryptographic technique known in the art, including generating each token identifier from a pseudo-random number generator or noise generator. Each token identifier may also be prefixed by an Issuer Identification Number (IIN) that uniquely identifies the financial institution (token issuer) that issued the respective identity token 226 or authorized the issuance of the respective identity token 226.

The token issuer server 300 may also confirm that each token identifier is unique within the accounts database 312, and may save each new token identifier in the accounts database 312 only after confirming that the token issuer has not previously associated the new token identifier with an identity token 226.

The computer-readable medium 310 also maintains computer processing instructions stored thereon which, when copied into the volatile computer-readable memory 308, and executed by the microprocessor(s) 306 from the volatile computer-readable memory 308, define an operating system 314 that controls the overall operation of the token issuer server 300. The computer processing instructions also implement an authorization processor 316 and a ledger update processor 318.

The authorization processor 316 is configured to receive an authorization request message from one of the POS terminals 200 via the associated acquirer network 230 and acquirer server 270. As discussed, the authorization request message includes the authorization amount and the token identifier received by the POS terminal 200, and requests authorization for a financial transaction in an amount equal to the authorization amount.

The authorization processor 316 is also configured to transmit an authorization response message to the POS terminal 200 via the acquirer network 230 and acquirer server 270. The authorization response message confirms that the financial transaction (characterized by the received token identifier and the authorization amount) was authorized.

The ledger update processor 318 is configured to receive an update command from one of the POS terminals 200 via the associated loyalty rewards network 240. As discussed, the update command includes the quantum of the loyalty points award and also includes the token identifier that was received by the POS terminal 200, and commands the ledger update server 300 to update the balance of loyalty points in the loyalty points ledger that is associated with the specified token identifier.

The ledger update processor 318 is also configured to post (without referencing the rules database 218 and without first responding to the update command) the quantum of the loyalty points award to the loyalty points ledger that is associated with the specified token identifier. Preferably, the ledger update processor 318 is configured to post the quantum of the loyalty points award to the loyalty points ledger only after the authorization processor 316 confirms that the financial transaction (characterized by the token identifier and the authorization amount) was authorized.

### Method of Updating a Ledger

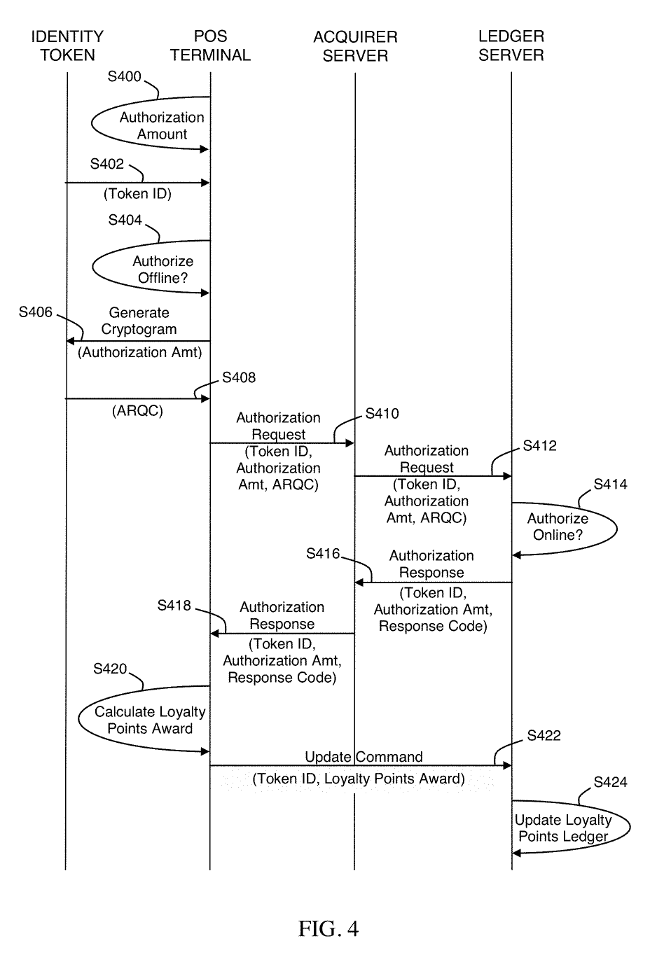

As discussed, the ledger update network 100 implements a method of updating a ledger. A sample embodiment of the ledger updating method will be discussed with reference to FIG. 4. As will be explained, in this embodiment the POS terminal 200 receives a token identifier and an authorization amount, generates an authorization request message from the token identifier and the authorization amount, and transmits the authorization request message to the token issuer server 300 via the associated acquirer network 230 and acquirer server 270. The authorization request message includes the token identifier and the authorization amount, and requests authorization from the ledger update server 300 for a financial transaction in an amount equal to the authorization amount.

The POS terminal 200 then generates an update command, and transmits the update command to the token issuer server 300 via the associated loyalty rewards network 240. The update command includes the token identifier and also includes the quantum of the loyalty points award to be awarded for the transaction, and commands the ledger update server 300 to update the balance of loyalty points in the loyalty point ledger that is associated with the specified token identifier.

In response to the authorization request message, the ledger update server 300 transmits an authorization response message to the POS terminal 200 via the acquirer network 230 and the acquirer server 270. The authorization response message confirms that the financial transaction (characterized by the token identifier and the authorization amount has been authorized). Without referencing the rules database 218 and without first responding to the update command, the ledger update server 300 posts the quantum of the loyalty points award to the loyalty point ledger that is associated with the token identifier.

The POS terminal 200 may generate the update command by (i) selecting one of the rules from the rules database 218, and (ii) generating the quantum of the loyalty points award from at least the selected rule. The POS terminal 200 may generate the quantum of the loyalty points award from both the authorization amount and the selected rule.

As discussed above, the token database 216 may include one or more authorized token identifier ranges. The POS terminal 200 may select a rule by first confirming that the token identifier correlates with one of the authorized token identifier ranges stored in the token database 216.

The rules in the rules database 218 may each be associated with a respective range of authorization values, and the POS terminal 200 may select a rule by retrieving from the rules database 218 a rule that has a range of authorization amounts that correlates with the specified authorization amount. The rules in the rules database 218 may each be associated with a respective class of goods/services, and the POS terminal 200 may select a rule by retrieving from the rules database 218 a rule that has a good/service class that correlates with the specified class. The rules in the rules database 218 may each be associated with a respective range of authorization values a respective class of goods/services, and the POS terminal 200 may select a rule by retrieving from the rules database 218 a rule that has a range of authorization amounts and a good/service class that respectively correlate with the specified authorization amount and the specified class.

The ledger update server 300 may authorize completion of the financial transaction, and may update the loyalty point ledger with the quantum of the loyalty points award after authorizing completion of the transaction.

An example ledger updating method will now be discussed in detail with reference to FIG. 4. In the following example, the memory 214 of the POS terminal 200 stores the token database 216 and the rules database 218, and the ledger update server 300 stores the accounts database 312. However, as discussed, the token database 216 and/or the rules database 218 may be stored on an ECR that is associated with each POS terminal 200, or on a local server that serves the POS terminals 200 on the merchant's local area network.

The POS terminals 200 may each be preconfigured with the token database 216 and the rules database 218. Alternately (or additionally), the ledger update server 300 may periodically update the respective token databases 216 and/or the respective rules databases 218 at times of the day when the associated POS terminals 200 are normally idle. In this variation, the POS terminals 200 may receive the database update(s) from the ledger update server 300 via the respective loyalty rewards network 240, and the POS terminals 200 may save the database update(s) in the respective token databases 216 and/or the respective rules databases 218.

Further, in the following example, the customer attends at the premises of a merchant to complete a credit payment transaction the merchant. Therefore, the identity token 226 that the customer interfaces with the merchant's POS terminal 200 is configured as a credit payment card. However, a similar method can be used to complete a debit payment transaction with the merchant by interfacing a debit payment card with the POS terminal 200.

After the customer attends at the POS terminal 200, at step S400 the merchant inputs the authorization amount into the POS terminal 200. The POS terminal 200 may receive the authorization amount directly via the input device 202 or indirectly via an ECR that is associated with the POS terminal 200.

The payment terminal 200 displays the authorization amount on the display device 204, and prompts the customer to approve the displayed authorization amount via the input device 202. The customer approves the displayed authorization amount, and the POS terminal 200 prompts the customer to interface an identity token 226 with the POS terminal 200. After the customer interfaces the identity token 226 with the token interface 206b, at step S402 the POS terminal 200 receives from the identity token 226 the token identifier that is stored on and uniquely associated with the identity token 226.

One or more token issuers may have each established a respective “floor limit” identifying the maximum authorization amount that can be authorized offline (i.e. without the POS terminal 200 requesting authorization from the respective token issuer). Accordingly, the token database 216 may store one or more floor limits each associated with a respective token identifier range. Therefore, at step S404, the authorization generator 222 may assess the risk associated with the financial transaction by (i) querying the token database 216 with the received token identifier to thereby retrieve from the token database 216 one of the token identifier ranges that correlates with the received token identifier, and (ii) comparing the received authorization amount against the floor limit that is associated with the retrieved token identifier range.

If the authorization generator 222 determines (at step S404) that the financial transaction (characterized by the received token identifier and the authorization amount) can be authorized offline (i.e. the received authorization amount does not exceed the specified floor limit), the authorization generator 222 may generate an authorization confirmation message that confirms that the financial transaction has been authorized offline. The POS terminal 200 may then display the authorization confirmation message on the display device 204. The merchant may subsequently initiate clearing of the financial transaction with the merchant's acquirer, in the conventional manner.

The identity token 226, interfaced with the token interface 206b, may be configured with the cryptographic keys and cryptographic algorithms that are required to authorize a financial transaction in accordance with the Europay Mastercard Visa (EMV) specification. Accordingly, if the identity token 226 implements the EMV specification, and the authorization generator 222 determines (at step S404) that the financial transaction cannot be authorized offline, at step S406 the authorization generator 222 creates a Generate Application Cryptogram command that includes the authorization amount, and transmits the Generate Application Cryptogram command to the identity token 226.

Upon receipt of the Generate Application Cryptogram command, the identity token 226 generates an online Application Request Cryptogram (ARQC) by applying, as inputs to a cryptographic algorithm implemented by the identity token 226, at least (i) the authorization amount, (ii) the token identifier, and (iii) a cryptographic session key generated by the identity token 226. The identity token 226 transmits the cryptogram ARQC to the POS terminal 200, at step S408, in response to the Generate Application Cryptogram command.

The authorization generator 222 then generates an authorization request message that includes the token identifier and the authorization amount (and the cryptogram ARQC, if the identity token 226 implements the EMV specification). The authorization request message explicitly or implicitly requests authorization for a financial transaction in an amount equal to the authorization amount.

At step S410, the POS terminal 200 transmits the authorization request message to the acquirer server 270 via the associated acquirer network 230. At step S412, the acquirer server 270 directs the authorization request message to the ledger update server 300, via the payment network 250, for online authorization of the financial transaction.

At step S414, the authorization processor 316 determines whether the financial transaction can be authorized online by confirming that the financial account that is associated with the token identifier is still active and has sufficient credit/funds to complete the transaction.

At step S414, the authorization processor 316 may also confirm that the identity token 226 generated the cryptogram ARQC (if included in the authorization request message) from the authorization amount. Consistent with the EMV specification, at step S414 the authorization processor 316 may validate the cryptogram ARQC by (i) recovering the cryptographic session key of the identity token 226 by applying the token identifier as an input to a key recovery algorithm (corresponding to that used by the identity token 226 to generate the cryptographic session key), (ii) decrypting the cryptogram ARQC with the recovered cryptographic key, (iii) computing a message authentication code from the authorization amount and the token identifier, and (iv) comparing the computed message authentication code against the decrypted cryptogram.

After the authorization processor 316 confirms that the financial account is active and has sufficient credit/funds (and optionally also confirms that the identity token 226 generated the cryptogram ARQC from the authorization amount), the authorization processor 316 generates an authorization response code indicating that the financial transaction was authorized. Otherwise, the authorization processor 316 generates an authorization response code indicating that the financial transaction was declined.

The authorization processor 316 then generates an authorization response message that includes the token identifier, the authorization amount and the authorization response code. At step S416, the authorization processor 316 transmits the authorization response message to the acquirer server 270 via the payment network 250.

At step S418, the acquirer server 270 then directs the authorization response message to the POS terminal 200 via the acquirer network 230. The POS terminal 200 may then provide a notification, on the display device 204, advising the customer whether the financial transaction was authorized online. The merchant may subsequently initiate clearing of the financial transaction with the merchant's acquirer, in the conventional manner.

The POS terminal 200 terminates the ledger updating method if the authorization response code indicates that the financial transaction was declined. Conversely, if the POS terminal 200 confirms that the financial transaction has been authorized (whether offline, at step S404; or online, at step S414), at step S420 the loyalty points generator 224 determines the quantum of the loyalty points that may be available to be awarded for the transaction.

As discussed, the rules database 218 may store rules that define parameters that the POS terminal 200 may use to determine the quantum of the loyalty points that can be awarded for a particular transaction. If the rules database 218 indicates that the same fixed quantum of loyalty points that should be awarded for each transaction, at step S420 the loyalty points generator 224 calculates the quantum of the loyalty points award by reading the fixed quantum value from the rules database 218.

If each rule in the rules database 218 identifies a respective range of authorization amounts and a weight factor that is applicable to the associated range, the loyalty points generator 224 selects a rule by retrieving from the rules database 218 a rule that has a range of authorization amounts that correlates with the specified authorization amount. At step S420, the loyalty points generator 224 calculates the quantum of the loyalty points award by multiplying the authorization amount by the weight factor of the retrieved rule.

If each rule in the rules database 218 identifies a respective group of good/services and a weight factor that is applicable to the associated group, the loyalty points generator 224 selects a rule by retrieving from the rules database 218 a rule that has a group of goods/services identifiers (e.g. SKUs) that correlates with the good/service identifier (e.g. SKU) of the good/service being purchased. At step S420, the loyalty points generator 224 calculates the quantum of the loyalty points award by multiplying the authorization amount by the weight factor of the retrieved rule.

If each rule in the rules database 218 identifies a respective range of authorization amounts, a respective group of good/services and a weight factor that is applicable to the associated authorization amount range and the associated group of goods/services identifiers, the loyalty points generator 224 selects a rule by retrieving from the rules database 218 a rule that has a range of authorization amounts that correlates with the specified authorization amount and a group of goods/services identifiers that correlates with the specified good/service identifier. At step S420, the loyalty points generator 224 calculates the quantum of the loyalty points award by multiplying the authorization amount by the weight factor of the retrieved rule.

At step S420, the loyalty points generator 224 may also determine whether the quantum of loyalty points should be awarded/withheld for the financial transaction. As discussed, the token database 216 may store one or more authorized token identifier ranges for which the respective token issuers have authorized the POS terminal 200 to award loyalty points. Alternately, the loyalty points generator 224 may be pre-configured with one or more authorized token identifiers ranges. Accordingly, at step S420 the loyal points generator 224 may determine that loyalty points should be awarded by querying the token database 216 with the token identifier to thereby confirm that the token identifier correlates with one of the authorized token identifier ranges. Conversely, the loyal points generator 224 may determine that loyalty points should be withheld by querying the token database 216 with the token identifier to thereby confirm that the token identifier does not correlate with any of the authorized token identifier ranges.

If the loyalty points generator 224 determines, at step S420, that the loyalty points should be withheld for the financial transaction (i.e. the received token identifier does not correlate with any of the authorized token identifier ranges stored in the token database 216), the POS terminal 200 may display a message on the display device 204, advising the customer of the quantum of the loyalty points that could have been awarded had the customer used one of the identity tokens 226 that were issued by the token issuer(s).

As discussed, if the authorization generator 222 authorizes the financial transaction offline (at step S404), of if the POS terminal 200 receives an authorization response message (at step S418) confirming that the financial transaction was authorized online, the POS terminal 200 may display an authorization confirmation message on the display device 204 advising that the transaction was authorized. Alternately, in one variation, the POS terminal 200 does not display multiple messages for the transaction. Instead, if the loyalty points generator 224 determines that the loyalty points should be withheld for the financial transaction, at step S420 the POS terminal 200 displays the authorization confirmation message on the display device 204 advising that the transaction was authorized (offline, online), together with the message advising the customer of the quantum of the loyalty points that could have been awarded had the customer used one of the identity tokens 226 that were issued by the token issuer(s).

Conversely, if the loyalty points generator 224 determines, at step S420, that the loyalty points can be awarded for the financial transaction (i.e. the received token identifier correlates with one of the authorized token identifier ranges, or the token database 216 does not include any authorized token identifier ranges), the loyalty points generator 224 generates an update command that (i) includes the token identifier and the quantum of the loyalty points award and (ii) commands the ledger update server 300 to increase the balance of loyalty points in the loyalty point ledger that is associated with the received token identifier, in an amount equal to the quantum of the loyalty points award. At step S422, the loyalty points generator 224 transmits the update command to the ledger update server 300 via the associated loyalty rewards network 240.

In each of the foregoing embodiments, the POS terminal 200 may transmit the update command to the ledger update server 300 in substantially real-time, after the POS terminal 200 determines that the financial transaction has been authorized, and after the POS terminal 200 determines that loyalty points can be awarded for the financial transaction and determines the quantum of the loyalty points award. The POS terminal 200 may also provide a notification, on the display device 204, in substantially real-time, advising the customer of the quantum of the loyalty points awarded for the transaction.

As discussed, if the authorization generator 222 authorizes the financial transaction offline (at step S404), or if the POS terminal 200 receives an authorization response message (at step S418) confirming that the financial transaction was authorized online, the POS terminal 200 may display an authorization confirmation message on the display device 204 advising that the transaction was authorized. Alternately, in one variation, the POS terminal 200 does not display multiple messages for the transaction. Instead, after the POS terminal 200 determines that loyalty points can be awarded for the financial transaction, and determines the quantum of the loyalty points award, the POS terminal 200 displays the authorization confirmation message on the display device 204 advising that the transaction was authorized (offline, online), together with the message advising the customer of the quantum of the loyalty points awarded for the transaction.

Since the update command is a command (not a request) to the ledger update server 300, after the ledger update server 300 receives the command from the POS terminal 200, at step S424 the ledger update processor 318 (i) queries the accounts database 312 with the received token identifier to thereby locate the loyalty points ledger that is associated with the token identifier, and (ii) increases the loyalty points balance in the located loyalty points ledger by an amount equal to the quantum of the loyalty points award, all without first responding to the update command.

Since the ledger update processor 318 updates the located loyalty points ledger (at step S424) with the quantum of the loyalty points award included in the update command, the ledger update processor 318 therefore updates the loyalty points balance without referencing the rules database 218.

As discussed above, since the ledger update server 300 does not receive an authorization request message to update the loyalty points ledger (which would then necessitate a corresponding authorization response message advising whether the update request was authorized or declined), but instead receives an update command commanding the ledger update server 300 to update the loyalty points ledger, the foregoing ledger update method allows the ledger update server 300 to post the quantum of the loyalty points award to the loyalty points ledger without responding to the update command. Consequently, the bandwidth requirements of the loyalty rewards networks 240 is reduced in comparison to conventional systems.

Further, as discussed, in each of the foregoing embodiments, the POS terminal 200 transmits the update command to the ledger update server 300 in substantially real-time after the POS terminal 200 determines the quantum of the loyalty points award. In one variation, instead of the POS terminal 200 transmitting the update command to the ledger update server 300 in substantially real-time, the POS terminal 200 transmits the update command to the ledger update server 300 well after the financial transaction has been authorized and well after the POS terminal 200 determines the quantum of the loyalty points award. For example, the POS terminal 200 may store several update commands in the volatile memory 212, and transmit all the stored update commands to the ledger update server 300 at the end of the business day. This latter variation may allow the bandwidth requirements to be further reduced, since the POS terminal 200 can transmit the update command(s) to the ledger update server 300 when the associated loyalty rewards network 240 is not heavily utilized.

1. A ledger update network comprising:
a point-of-sale terminal; and
a computer server including a database of ledgers each uniquely associated with a respective token identifier,
wherein the point-of-sale terminal is configured to:
(a) receive a primary authorization value and one of the token identifiers;
(b) generate an authorization request message, the authorization request message including the received token identifier and the primary authorization value;
(c) generate an update command by (i) selecting a rule from a rules database, and (ii) generating a secondary authorization value from at least the selected rule, the update command including the received token identifier and the secondary authorization value, the rules database comprising at least one of the rules; and
(d) transmit the authorization request message and the update command to the computer server; and
wherein the computer server is configured to:
(a) receive the authorization request message and the update command from the point-of-sale terminal;
(b) transmit an authorization response message to the point-of-sale terminal, the authorization response message confirming authorization of a transaction characterized by the received token identifier and the primary authorization value; and
(c) without referencing the rules database and without first responding to the update command, post the secondary authorization value to the ledger associated with the received token identifier.

2. The ledger update network according to claim 1, wherein the point-of-sale terminal is configured to receive from the computer server a range qualifier identifying a range of token identifiers, and to transmit the update command after confirming that the received token identifier correlates with the range.

3. The ledger update network according to claim 2, wherein the point-of-sale terminal includes a memory, and the point-of-sale terminal is configured to receive the at least one rule from the computer server, and to save the received at least one rule in the memory in the rules database.

4. The ledger update network according to claim 2, wherein the rules are each associated with a respective authorization value range, and the point-of-sale terminal is configured to select a rule by correlating the received primary authorization value with one of the authorization value ranges.

5. The ledger update network according to claim 1, wherein the point-of-sale terminal is configured to compute the secondary authorization value from the primary authorization value and the selected rule.

6. The ledger update network according to claim 1, wherein the computer server is configured to post the secondary authorization value by updating the associated ledger with the secondary authorization value after authorizing completion of the transaction.

7. The ledger update network according to claim 1, wherein the point-of-sale terminal is configured to transmit the authorization request message to the computer server via a primary communications network, and to transmit the update command to the computer server via a secondary network different from the primary communications network.

8. A method of updating ledgers each uniquely associated with a respective token identifier, the method comprising:
a point-of-sale terminal receiving a primary authorization value and one of the token identifiers;
the point-of-sale terminal generating an authorization request message, the authorization request message including the received token identifier and the primary authorization value;
the point-of-sale terminal generating an update command by (i) selecting a rule from a rules database, and (ii) generating a secondary authorization value from at least the selected rule, the update command including the received token identifier and the secondary authorization value, the rules database comprising at least one of the rules;
the point-of-sale terminal transmitting the authorization request message and the update command to a computer server;
the computer server receiving the authorization request message and the update command from the point-of-sale terminal;
the computer server transmitting an authorization response message to the point-of-sale terminal, the authorization response message confirming authorization of a transaction characterized by the received token identifier and the primary authorization value; and
without referencing the rules database and without first responding to the update command, the computer server posting the secondary authorization value to the ledger associated with the received token identifier.

9. The method according to claim 8, wherein the transmitting the update command comprises the point-of-sale terminal receiving from the computer server a range qualifier identifying a range of token identifiers, and confirming that the received token identifier correlates with the range.

10. The method according to claim 9, wherein the point-of-sale terminal includes a memory, and the generating an update command further comprises the point-of-sale terminal receiving the at least one rule from the computer server, and saving the received at least one rule in the memory in the rules database.

11. The method according to claim 9, wherein the rules are each associated with a respective authorization value range, and the selecting a rule further comprises the point-of-sale terminal correlating the received primary authorization value with one of the authorization value ranges.

12. The method according to claim 8, wherein the generating a secondary authorization value comprises the point-of-sale terminal computing the secondary authorization value from the primary authorization value and the selected rule.

13. The method according to claim 8, wherein the providing an authorization response message comprises the computer server authorizing completion of the transaction, and wherein the posting the secondary authorization value comprises the computer server updating the associated ledger with the secondary authorization value after the authorizing completion of the transaction.

14. The method according to claim 8, wherein the transmitting the authorization request message and the update command comprises the point-of-sale terminal transmitting the authorization request message to the computer server via a primary communications network, and transmitting the update command to the computer server via a secondary network different from the primary communications network.

15. A point-of-sale terminal comprising:
a data input device;
a display device;
a token interface;
a memory storing a rules database comprising at least one rule; and
a data processor in communication with the data input device, the display device, the token interface and the memory, wherein the data processor is configured to:
receive a primary authorization value from the data input device, and receive a token identifier from an identity token interfaced with the token interface;
generate an authorization request message, the authorization request message including the token identifier and the primary authorization value;
generate an update command by (i) selecting a rule from the rules database, and (ii) generate a secondary authorization value from at least the selected rule, the update command including the token identifier and the secondary authorization value;
transmit the authorization request message to a computer server;
receive an authorization response message from the computer server, the authorization response message confirming authorization of a transaction characterized by the token identifier and the primary authorization value;
display the secondary authorization value on the display device; and
transmit the update command to the computer server after displaying the secondary authorization value.

16. The point-of-sale terminal according to claim 15, wherein the data processor is configured to receive from the computer server a range qualifier identifying a range of token identifiers, and to transmit the update command after confirming that the received token identifier correlates with the range.

17. The point-of-sale terminal according to claim 16, wherein the data processor is configured to receive the at least one rule from the computer server, and to save the received at least one rule in the rules database.

18. The point-of-sale terminal according to claim 16, wherein the rules are each associated with a respective authorization value range, and the data processor is configured to select a rule by correlating the received primary authorization value with one of the authorization value ranges.

19. The point-of-sale terminal according to claim 15, wherein the data processor is configured to compute the secondary authorization value from the primary authorization value and the selected rule.

20. The point-of-sale terminal according to claim 15, wherein the data processor is configured to transmit the authorization request message to the computer server via a primary communications network, and to transmit the update command to the computer server via a secondary network different from the primary communications network.
